(19) United States
(12) Patent Application Publication
(10) Pub. No.: US 2010/0167897 A1
(43) Pub. Date: Jul. 1, 2010

(54) STRUCTURE FOR FOLDING TRAYS OF A PAPER FOLDER

(76) Inventor: Jen-Che CHIANG, Taipei Hsien (TW)

Correspondence Address: Muncy, Geissler, Olds & Lowe, PLLC, 4000 Legato Road, Suite 310, FAIRFAX, VA, 22033, US

(21) Appl. No.: 12/650,210

(22) Filed: Dec. 30, 2009

(30) Foreign Application Priority Data
Dec. 31, 2008 (TW) 097223717

(51) Int. Cl. B31F 1/00

(52) U.S. Cl. 493/405

(57) ABSTRACT

The present invention relates to a structure for folding trays of a paper folder and comprises a casing body which includes a case inside the shell of the casing body for installing various components inside; a feed paper tray mechanism pivotally installed inside the casing body, which includes a feed paper tray reaching into the casing body for keeping the paper to be folded; a feeding roller mechanism pivotally installed in the case of the casing body, which normally holds and presses against the paper in the feed paper tray to roll and feed the paper; a folding roller train pivotally installed inside the casing body to receive and fold the paper from the feeding roller mechanism in order; a folding tray mechanism consisting of sub-circular cylindrical folding trays that are fixed inside the casing body, which can adjust and decide the fold size according to fold types and work with the folding roller train to carry out folding of the paper; and a power mechanism that drives the feeding roller mechanism and rollers of the folding roller train to rotate at a proposed speed towards a certain direction.

This application claims the priority benefit of Taiwan patent application number 097223717, filed on Dec. 31, 2008.

### BACKGROUND OF THE INVENTION

1. Field of the Invention

The present invention relates to an improved structure for folding trays of a paper folder, particularly, to the structure under which paper is fed into a proposed number of roller trains and sub-circular double-layer cylindrical folding trays, so that the paper will be temporarily folded in sequence into forms to facilitate simple and accurate adjustment of fold size through regular operation, simplify production of the folding trays and reduce the installation space.

2. Description of the Prior Art

For a conventional paper folder (as shown in FIGS. 1-3), paper (P) is placed in a feed paper tray (A), and is pushed automatically by a feed roller (R) into a first set of rollers (R1) and (R2), which rolls the paper into a first folding tray (B1) in the rolling direction. Inside the first folding tray (B1), the paper will be retained by a baffle (C) which is able to adjust and position the paper and set a first fold size. The first set of rollers (R1) and (R2) continues to roll and push the paper (P) into a second set of rollers (R2) and (R3) with a bending angle (P0) (as shown in FIG. 1), thus, the bent paper will be clamped and folded by the second set of rollers (R2) and (R3) in a proposed position, and be pushed in the rolling direction into the a second folding tray (B2), inside which the bent paper is kept off by the baffle (C) capable of adjusting and positioning it. Similar to the bending state for the second set of rollers (R2) and (R3), the paper is again rolled, clamped and folded by a third set of rollers (R3) and (R4) into a proposed second fold size in a proposed fold form (e.g. inward triple-fold, outward triple-fold or double-fold), pushed into a proposed folding tray and retained by a baffle (D) for sealing (as shown in FIG. 1), thus allowing the paper to be bent and folded into different types of folds. With regard to the structure of the baffle (C) for adjusting and fixing in each of the folding trays, there are two adjusting screws pivotally installed in parallel and symmetrically on top of each folding tray, and an engagement sleeve (E) is installed around each of the adjusting screws for achieving and releasing engagement and connected to the baffle (C). By moving a cuing scale (F) installed between the two engagement sleeve (E) to the graduation value of a scale (G) on either side, users can rotate buttons (S1) of the adjusting screws (S) to adjust the cuing scale (F) finely and align it with the values on either side of the scale (G), thus achieving fine adjustment of folding verticality for the baffle (C) when it retains the paper (as shown in FIGS. 2&3). In some cases, a single adjusting screw (S) may be used to adjust and fix the baffle (C) roughly (as shown in FIG. 4), and fine adjustment of the button (S1) is achieved by rotating to align with the position to retain the paper on the scale (G). Then, users may finely adjust the folding verticality for the baffle (C) by rotating a fine adjusting screw (S2) at the outward end of the cuing scale (F).

However, the feed paper tray (A) and folding trays (B) of the conventional paper folder reach and hang into the framework of the paper folder within a proposed distance atop and at the bottom, leaving part of the feed paper tray (A) and folding trays (B) placed outside the framework. Since the adjusting screws (S), find adjusting screw (S2), engagement sleeves (E), cuing scale (F) and scale (G) are placed below the feed paper tray (A) atop or folding trays (B), it is often difficult for users to see alignment of the cuing scale (F) with the scale (G) when they stretch out their hands trying to adjust the position of the engagement sleeve (E). Or, due to the limited fold space above and below the feed paper tray (A) and folding trays (B), it is very inconvenient for users to stretch out their hands into the space for adjusting the engagement sleeve (E). As a result, they have to take down the folding trays below before they can make fine adjustments quickly and accurately. In case of a large paper folder, more employees and time will be needed for disassembly and assembly of the folding trays. In addition, repeated adjustment of the double adjusting screws or single adjusting screw (S) is required to fix the position accurately for retaining and folding the paper, which will also take considerable time and energy. Moreover, there will be noise when the paper (P) pushes against the baffle (C), and if users need to stretch out and take back their hands for adjustment, they may suffer from spreading of such noise and dust due to open design of the framework (H). Even if an anti-noise cover is installed, it cannot have significant effect due to proximity of the trays to the adjusting components and limited space for installing the anti-noise cover. Furthermore, if the anti-noise cover is installed, it is likely that it will be put aside, since it is really inconvenient to dismount the cover for adjusting the baffle (C) and restore it for soundproofing, or it will not endure use as it is likely to be damaged in that process. Besides, as the folding trays, like flat discs, cannot be placed at a large inclined angle to have impact on the feed angle at the exit of all sets of rollers and folding trays, which means that these trays will occupy considerable space visibly and invisibly for benefit of transverse disassembly and assembly and reaching and hanging into the framework (H), thus, the disadvantages of the conventional paper folder are clear. In view of these disadvantages and problems as indicated above, the inventor has made detailed researches and improvements, carried out experiments many times and finally invented the structure for folding trays of a paper folder in the present invention.

### SUMMARY OF THE INVENTION

The primary object of the present invention is to provide a structure for folding trays of a paper folder, in which the proposed sub-circular cylindrical folding trays can receive and keep the paper to be folded smoothly by enabling users to set a flexible angle for receiving the paper. It helps reduce the volume of the machine and the space for placing it with the simple design that integrates the cover into the machine to reduce noise.

The secondary object of the present invention is to provide a structure for folding trays of a paper folder, in which adjusting components are installed at the center of the sub-circular cylindrical folding trays to retain and bend the paper, enabling users to operate quickly, easily and directly without minute adjustments in the retaining and folding position, as what needs to be done for a conventional paper folder, and eliminating the disadvantages in dismounting and mounting the folding trays for fine adjustments.

The further object of the present invention is to provide a structure for folding trays of a paper folder, in which spindle components are installed at the center of the cylindrical folding trays to retain and bend the paper, and these components enable verticality to the feed paper to be kept as they rotate and move without making fine adjustments in verticality after the retaining and folding position is decided, as what has to be done to a conventional paper folder.

Technically, the present invention relates to a structure for folding trays of a paper folder and comprises a casing body which includes a case inside the shell of the casing body for installing various components inside; a feed paper tray mechanism pivotally installed inside the casing body, which includes a feed paper tray reaching into the casing body for keeping the paper to be folded; a feeding roller mechanism pivotally installed in the case of the casing body, which normally holds and presses against the paper in the feed paper tray to roll and feed the paper; a folding roller train pivotally installed inside the casing body to receive and fold the paper from the feeding roller mechanism in order; a folding tray mechanism consisting of sub-circular cylindrical folding trays that are fixed inside the casing body, which can adjust and decide the fold size according to fold types and work with the folding roller train to carry out folding of the paper; and a power mechanism that drives the feeding roller mechanism and rollers of the folding roller train to rotate at a proposed speed towards a certain direction.

An example is given to further illustrate the embodiments of the present invention with reference to the accompanying drawings to fully describe the features and functions of the present invention.

### BRIEF DESCRIPTION OF THE DRAWINGS

FIG. 1 is an assembly section drawing of a conventional paper folder from a side view.

FIG. 2 schematically shows a folding tray of a conventional paper folder from a top view.

FIG. 3 shows an assembly section of a folding tray of a conventional paper folder from a side view

FIG. 4 is a schematic drawing of a folding tray of another paper folder from a vertical view.

FIG. 5 is an assembly sectional drawing of the present invention from a side view.

FIG. 6 is an assembly sectional drawing of the present invention from a front view

FIG. 7 shows the operation of the present invention schematically.

FIG. 8 shows an assembly section according to another embodiment of the present invention from a side view.

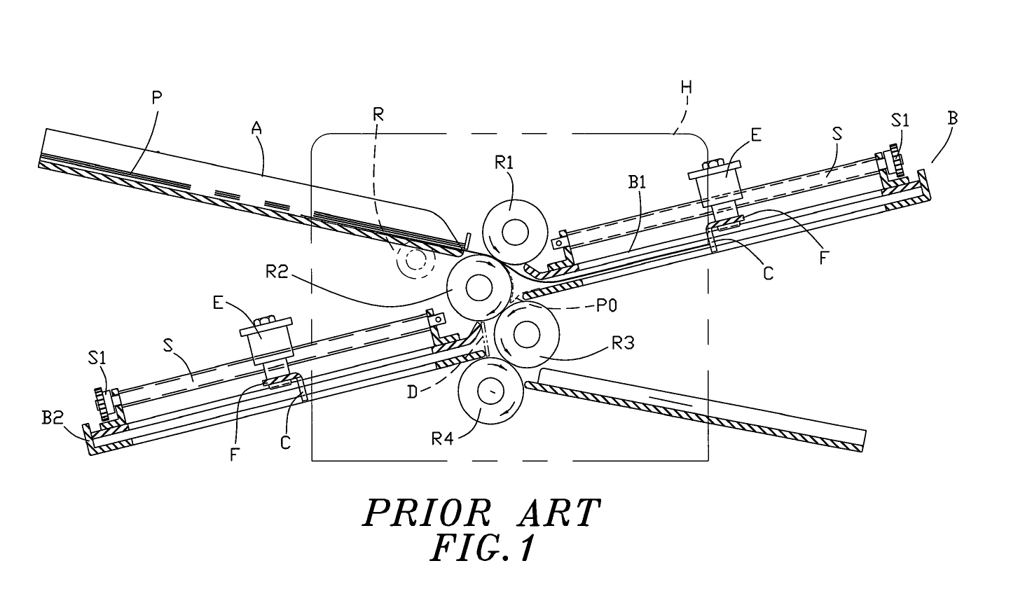

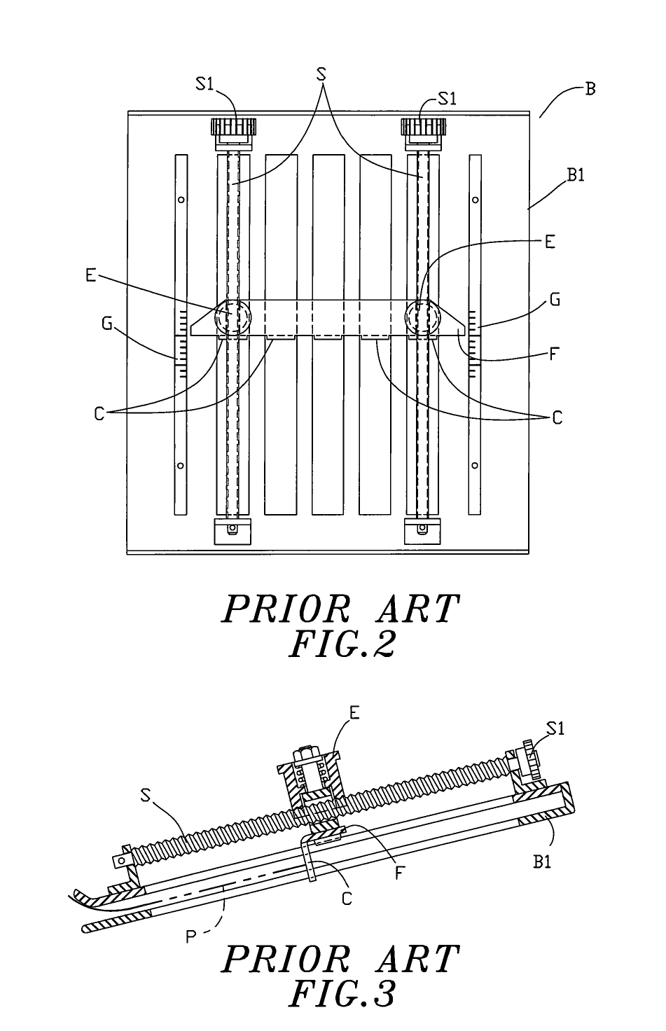

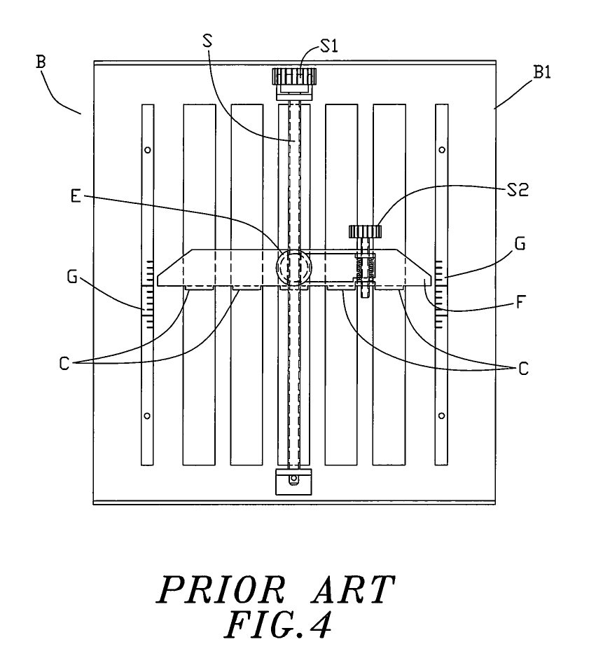

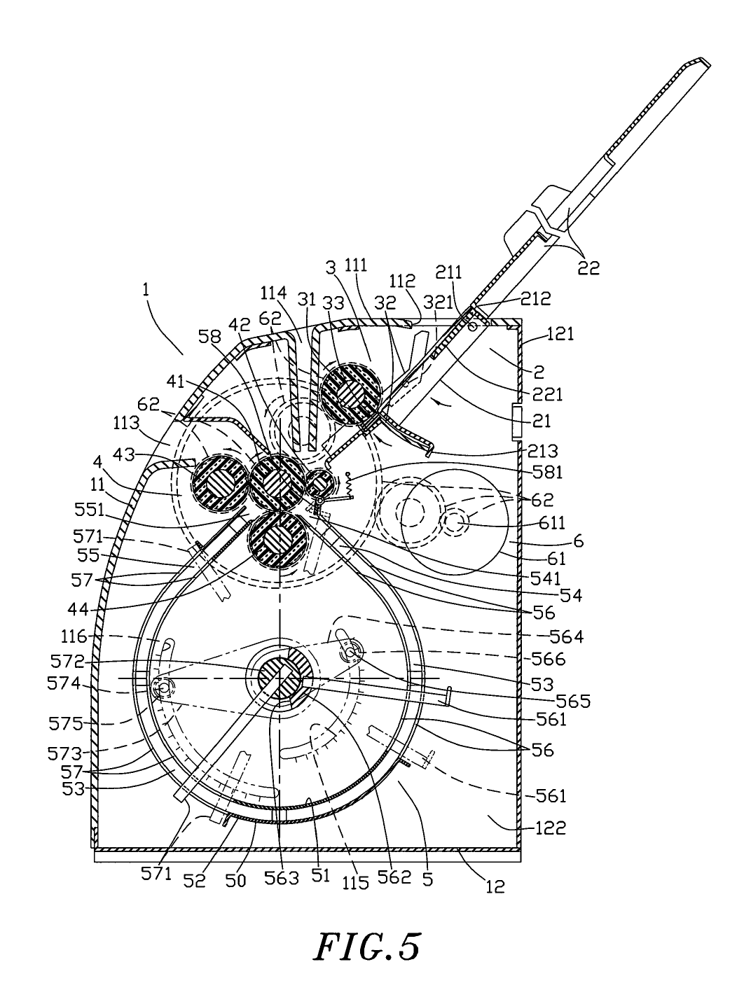

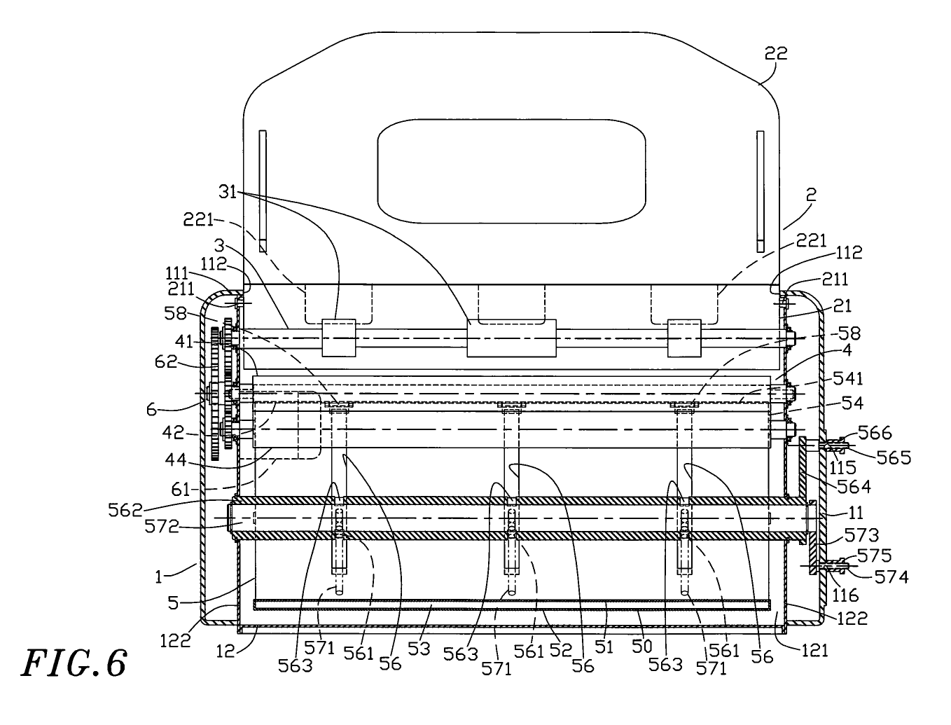

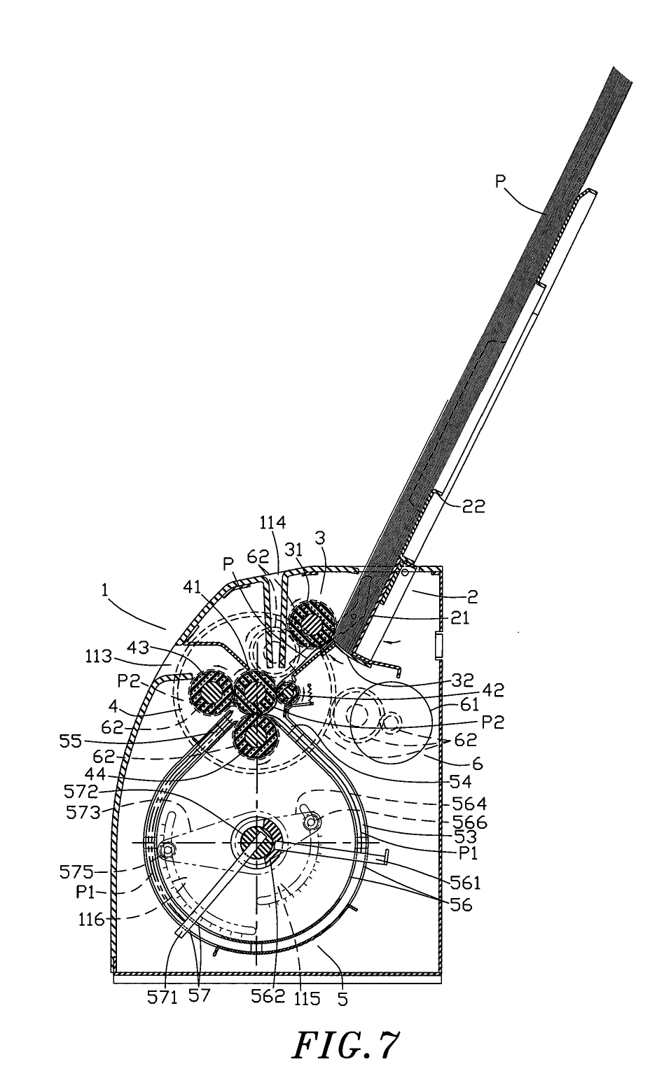

### DETAIL DESCRIPTION OF THE INVENTION

Refer to FIGS. 5&6, which show that the present invention mainly comprises: a casing body 1, a feed paper tray mechanism 2, a feeding roller mechanism 3, a folding roller train 4, a folding tray mechanism 5 and a power mechanism 6.

There is a case 12 inside a shell 11 of the casing body 1, and a long groove 112 is set on a top plate 111 of the shell 11 close to a back 121 of the case 12, so that the front end of a base 21 of the feed paper tray mechanism 2 is installed on a supporting pivot 211 and placed between two side walls 122 of the case 12 close to the inward edge of the long groove 112.

There are multiple groove holes 212 that cut through the front end of the base 21, and these holes can be inserted and fixed by latch plates 221 installed at the bottom edge of a feed paper tray 22 of the feed paper tray mechanism 2. The front end of the base 21 includes a stopper block 213, and a spring mechanism is used to press the base 21 towards a feed paper roller 31 of the feeding roller mechanism 3 in a proposed position (the spring mechanism is not described nor illustrated here, since it is related to the prior art.), while the stopper block 213 will stop the base 21 when it comes close to a paper support base 32 of the feeding roller mechanism 3.

The paper support base 32 of the feeding roller mechanism 3 is pivotally fixed by a latch pivot 321 in a proposed position between the two side walls 122 of the case 12, and includes a paper pickup cushion block 33 standing against the feed paper roller 31. A spring mechanism is used to press the paper pickup cushion block 33 against the feed paper roller 31 (The spring mechanism is not described nor illustrated here, since it is related to the prior art.).

The folding roller train 4 is pivotally placed in a proposed position between the two side walls 122 of the case 12, and it has a major roller 41 that touches against a paper advance roller 42 and a paper delivery roller 43 respectively on one side. The paper advance roller 42 works with the feed paper roller 31 to decide on the advancing distance for the paper, and the paper delivery roller 43 faces against the paper outlet 113 on the front surface of the shell 11. A folding roller 44 touches against the bottom edge of the major roller 41 between the paper advance roller 42 and the paper delivery roller 43. In the middle of the top plate 111 of the shell, there is a one-sheet feed inlet 114 facing the position where the major roller 41 and the paper advance roller 42 meet. A folding tray 50 of the folding tray mechanism 5 is fixed in a proposed position between the two side walls 122 of the case 12, and consists of two sub-circular cylindrical boards of a proposed radius 51 and 52, which are fixed and combined concentrically and in parallel at a proposed interval to form a sub-circular cylindrical board groove 53. One end of the sub-circular cylindrical board groove 53 connects through a first folding board groove 54, so that a groove outlet 541 of the first folding board groove 54 aligns with the position where the major roller 41 and the paper advance roller 42 meet; and the other end of the sub-circular cylindrical board groove 53 connects through a second folding board groove 55, making a groove outlet 551 align with the position where the major roller 41 and the paper delivery roller 43 meet. At the ends of the sub-circular cylindrical board groove 53 of the folding tray 50 that are connected with the first folding board groove 54 and the second folding board groove 55, first folding grooves 56 and second folding grooves 57 with a proposed length cut through symmetrically according to the dimensions for folding the paper. The number and length of these grooves are equal, and the grooves 56 and 57 include a first folding battle rod 561 and a second folding baffle rod 571 respectively.

The first folding battle rod 561 and second folding baffle rod 571 are fixed at the center of the sub-circular cylindrical board groove 53, and are pivotally mounted on a first folding pivot 562 and a second folding pivot 572, which are pivotally fixed on the walls 122 of the shell 12. And groove holes 563 at a proposed angle are set on the first folding pivot 562 that cuts through the second folding baffle rod 571.

One end of the first folding pivot 562 and second folding pivot 572 extends and connects to one end of a first folding crank 564 and a second folding crank 573 respectively, while the other end of these cranks is connected to bolts 565 and 574 that protrude from the walls of the shell and correspond to a first folding long hole 115 and a second folding hole 116 in line with the folding arc created by the first folding grooves 56 and second folding grooves 57. And the folding long holes 115 and 116 rotate to form fixing sleeves 566 and 575. Folding scales are indicated on the edge of the first folding long hole 115 and second folding hole 116.

A cover plate 58 is pivotally installed on the groove outlet 541 of the first folding board groove 54 close to the position where the major roller 41 and the paper advance roller 42 meet. And the cover plate 58 leans against the walls of the first folding board groove 54 due to effect of a spring 581, leaving the groove outlet 541 open normally. When the first folding baffle rod 561 moves pivotally to press the cover plate 58 to close the groove outlet 541 of the first folding board groove 54, it will prevent the paper from entering to provide different folds.

A power unit 61 of the power mechanism 6 is fixed on the walls of the case 12, and includes a power shaft 611 that pierces through the walls and connects with a transmission gear set 62, which drive the rollers of the feeding roller mechanism 3 and folding roller train 4 to rotate at a proposed speed towards a proposed direction. For use of the present invention, loosen the two fixing sleeves 566 and 575 and move the folding cranks 564 and 573 to a proposed scale on the edge of the two long holes 115 and 166. At the same time, make the folding pivots 562 and 572 move in order to rotate the folding baffle rods 561 and 571. In a proper position of the first and second folding grooves 56 and 57, put sheets of paper into the feed paper tray 22 of the feed paper tray mechanism 2 in a timely manner, and the paper sheets will move along the base 21 and enter into the paper support base 32 of the feeding roller mechanism 3, and will be pressed by the spring of the base 21 into the feed paper roller 31.

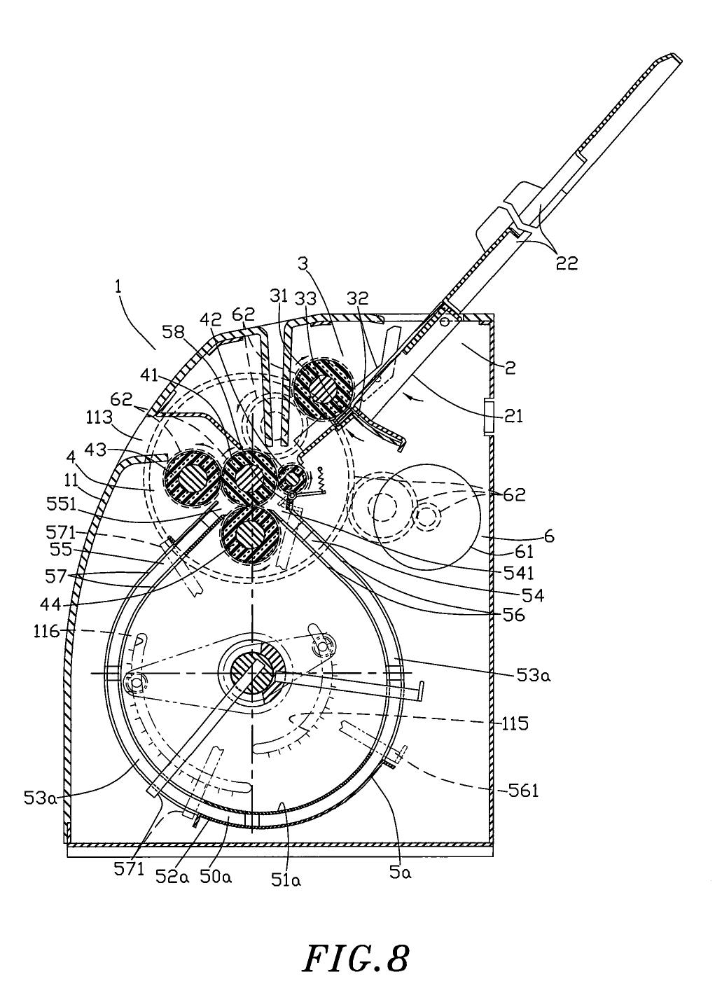

When the paper folder recognizes that the paper is in position by detecting, it will start the power unit 61 to put the rollers in motion via the transmission gear set 62, making the feed paper roller 31 rotate to rub and press against the paper and roll the paper into the position where the major roller 41 and paper advance roller 42 of the folding roller train 4 meet. The paper will be rolled and pushed into the first folding board groove 54 and further into sub-circular cylindrical board groove 53 of the folding tray mechanism 5, till it is retained by the first folding baffle rod 561. And the major roller 41 and the paper advance roller 42 will continue to roll and push the paper forward, making the paper bend and move towards the place where the major roller 41 and the folding roller 44 meets, thus making the paper be rolled forward in its fold state (as shown in FIG. 7). In addition, the paper will be retained at a folding end (P1) of the first folding board groove 54 and be pulled out while it is folded and rolled forward, then it will continue to coincide at a feeding end (P2) and be pushed into the second folding board groove 55, where it will be retained by the second folding baffle rod 571, making the paper bend at the feeding end (P2) of the major roller 41 and folding roller 44 and move towards the place where the major roller 41 and the paper delivery roller 43 meet. This will cause the paper in a folding state to be rolled forward (as shown by the dotted line in FIG. 7), and at the same time, be pulled out from the second folding board groove 55 following completion of folding and sent out through the outlet 113 on the surface of the shell 11. In the present invention, the curvature radius and arc length of the sub-circular cylindrical board groove 53a of the folding tray 50a of the folding tray mechanism 5a can also be preset, and the sub-circular cylindrical board groove 53a may comprise two symmetrical or asymmetrical curved surface cylindrical boards 51a and 52a that are fixed and invaginated in parallel with an interval between them (as shown in FIG. 8). For the present invention, folding roller trains can be added to connect with the folding tray mechanism if complex paper folds are needed.

In summary, based on the descriptions of the fabrication, functions and objects given above, the structure for folding trays of a paper folder in the present invention is more perfect and applicable than that of conventional paper folders, and includes novelty and inventive steps. All these are sufficient to prove that the present invention is novel, practically applicable and simple. It can help improve functions of conventional paper folders by eliminating their disadvantages, and makes full use of concentric design for sub-circular cylindrical grooves to facilitate quick and easy operation by simply installing the mechanisms used for adjusting folding and retaining positions outside an insulative shell. In addition, no articles with the same or similar characteristics are seen in domestic and foreign publications or used publicly. Therefore, the present invention really satisfies conditions for patentability of an invention.

The disclosed descriptions, examples and drawings are given here to illustrate an example of the preferred embodiments of the present invention. However, these shall not be construed as limiting the scope of the patent claims of the present invention. Therefore, all modifications and equivalent structural changes made without departing from the spirit of the art and scope disclosed in the present invention shall be included in the patent claims of the present invention.

What the invention claimed is:

1. A structure for folding trays of a paper folder, comprising:
a casing body, inside the shell of which a case is installed for containing various components; a long groove is set on the top plate of the shell and a paper outlet is set on the front panel of the shell;
a feed paper tray mechanism, pivotally installed in a position between two side walls of the case close to the long groove on the shell of the casing body, and which includes a feed paper tray that protrudes for keeping the paper to be folded;
a feeding roller mechanism pivotally installed in a position between the two side walls of the case of the casing body, which includes a paper support base and a feeding roller that normally support and press against the paper in the feed paper tray of the feed paper tray mechanism so as to roll and feed the paper;
a folding roller train pivotally installed in a position between the two side walls of the case of the casing body, which includes a major roller touching against a paper advance roller and a paper delivery roller respectively on one side, wherein the paper advance roller works with the feed paper roller to decide on the advancing distance for the paper, and the paper delivery roller faces against the paper outlet on the surface of the shell; a folding roller touches against the bottom edge of the major roller in a position between the paper advance roller and the paper delivery roller;
a folding tray mechanism, including a folding tray that is fixed in a position between the two side walls of the case of the casing body to receive and fold the paper from the folding roller train;
and a power mechanism that drives the feeding roller mechanism and rollers of the folding roller train to rotate at a proposed speed towards a certain direction, which has the following characteristics:
the folding tray of the folding tray mechanism comprises two sub-circular cylindrical boards of a proposed radius, which are fixed and invaginated concentrically and in parallel at a proposed interval to form a sub-circular cylindrical board groove; one end of the sub-circular cylindrical board groove connects through a first folding board groove formed by the two boards at equal intervals, so that a groove outlet of the first folding board groove aligns with the position where the major roller and the paper advance roller meet; and the other end of the sub-circular cylindrical board groove connects through a second folding board groove formed by the two boards at equal intervals, making a groove outlet align with the position where the major roller and the paper delivery roller meet; at the ends of the sub-circular cylindrical board groove of the folding tray that are connected with the first folding board groove and the second folding board groove, first folding grooves and second folding grooves with a proposed length cut through symmetrically; the number and length of these grooves are equal, and the grooves include a first folding battle rod and a second folding baffle rod respectively; a first folding pivot and a second folding pivot are pivotally mounted at the center of the sub-circular cylindrical board groove and on the two side walls of the cases of the shell, and these pivots are connected with a first folding battle rod and second folding baffle rod in the two folding grooves for adjustments.

2. The structure for folding trays of a paper folder according to claim 1, wherein the first folding grooves and second folding grooves are established at the ends of the sub-circular cylindrical board groove of the folding tray mechanism connected with the first folding board groove and the second folding board groove to exercise control over folding dimensions in accordance with paper folds.

3. The structure for folding trays of a paper folder according to claim 1, wherein the grooves on the first folding pivot of the folding tray mechanism are established to correspond to the maximum rotation angle of the second folding baffle rod, so as to provide enough space for rotation and motion of the second folding baffle rod.

4. The structure for folding trays of a paper folder according to claim 1, wherein one end of the first folding pivot and second folding pivot extends and connects to one end of a first folding crank and a second folding crank respectively, while the other end of these cranks is connected to bolts that protrude from the walls of the shell and correspond to a first folding long hole and a second folding hole in line with the folding arc created by the first folding grooves and second folding grooves; and the folding long holes rotate to form fixing sleeves for adjusting and fixing purpose.

5. The structure for folding trays of a paper folder according to claim 1, wherein a cover plate is pivotally installed on the groove outlet of the first folding board groove close to the position where the major roller and the paper advance roller meet, and the cover plate leans against the walls of the first folding board groove due to effect of a spring, leaving the groove outlet open normally; when the first folding baffle rod moves pivotally to press the cover plate to close the groove outlet of the first folding board groove, it will prevent the paper from entering to provide different folds.

6. The structure for folding trays of a paper folder according to claim 1, wherein the sub-circular cylindrical board groove of the folding tray of the folding tray mechanism has a proposed curvature radius and arc length, and comprise two symmetrical curved surface cylindrical boards that are fixed and invaginated in parallel with an interval between them.

7. The structure for folding trays of a paper folder according to claim 1, wherein the sub-circular cylindrical board groove of the folding tray of the folding tray mechanism has a proposed curvature radius and arc length, and comprise two asymmetrical curved surface cylindrical boards that are fixed and invaginated in parallel with an interval between them.

8. The structure for folding trays of a paper folder according to claim 3, wherein one end of the first folding pivot and second folding pivot extends and connects to one end of a first folding crank and a second folding crank respectively, while the other end of these cranks is connected to bolts that protrude from the walls of the shell and correspond to a first folding long hole and a second folding hole in line with the folding arc created by the first folding grooves and second folding grooves; and the folding long holes rotate to form fixing sleeves for adjusting and fixing purpose.
